(19) United States
(12) Patent Application Publication
(10) Pub. No.: US 2024/0042830 A1
(43) Pub. Date: Feb. 8, 2024

(54) COOLING MODULE FOR AN ELECTRIC OR HYBRID MOTOR VEHICLE, HAVING A TANGENTIAL-FLOW TURBOMACHINE

(71) Applicant: Valeo Systemes Thermiques, Le Mesnil-Saint-Denis (FR)

(72) Inventors: Amrid Mammeri, Le Mesnil-Saint-Denis (FR); Kamel Azzouz, Le Mesnil-Saint-Denis (FR); Issiaka Traore, Le Mesnil-Saint-Denis (FR); Sebastien Garnier, Le Mesnil-Saint-Denis (FR)

(73) Assignee: Valeo Systemes Thermiques, Le Mesnil-Saint-Denis (FR)

(21) Appl. No.: 18/276,911

(22) PCT Filed: Feb. 9, 2022
(86) PCT No.: PCT/EP2022/053151

§ 371 Date: Aug. 11, 2023

(30) Foreign Application Priority Data
Feb. 11, 2021 (FR) FR2101300

(51) Int. Cl. B60H 1/32; B60H 1/00

(52) U.S. Cl. CPC B60H 1/32; B60H 1/00564; B60Y 2200/90; B60Y 2400/435; B60Y 2306/05; B60H 2001/00707

(57) ABSTRACT

The invention relates to a cooling module for a motor vehicle, comprising a fairing forming an internal duct inside which at least one heat exchanger intended to have an air flow (F) passing through it is arranged, a collector housing positioned downstream of the fairing and further comprising one or more side walls which extend in the continuation of the internal duct of the fairing, the cooling module being characterized in that the at least one side wall comprises at least one vent (E) intended to discharge the air flow (F), as well as at least one shut-off device for shutting off the at least one vent (E), said shut-off device being able to move between a position in which said at least one vent (E) is open and a position in which said at least one vent (E) is closed.

The invention relates to a cooling module for an electric or hybrid motor vehicle, having a tangential-flow turbomachine.

A cooling module (or heat exchange module) of a motor vehicle conventionally comprises at least one heat exchanger and a ventilation device which is designed to generate a flow of air in contact with the at least one heat exchanger. This ventilation device takes, for example, the form of a tangential-flow turbomachine notably able to generate a flow of air in contact with the heat exchanger or exchangers, particularly when the vehicle is stationary or when it is moving at low speed.

When the vehicle is running along, the high speed of the vehicle may be sufficient to create the air flow without assistance from the tangential-flow turbomachine. However, the tangential-flow turbomachine may act as an obstacle to the flow of air passing through the cooling module, thus greatly increasing pressure drops, which may be damaging to the correct operation of the heat exchangers and potentially impair the aerodynamics of the motor vehicle. In order to overcome this disadvantage, the cooling module may comprise, in addition to the air outlet of the tangential-flow turbomachine, at least one other opening situated on a rear face of the cooling module, this rear face being juxtaposed with the air outlet of the tangential-flow turbomachine. Thus, when the vehicle is running and has reached a sufficient speed, this or these openings make it possible to allow the air flow to pass through and to bypass the tangential-flow turbomachine.

The cooling module may moreover comprise at least one shut-off device enabling the additional opening or openings to be closed off. This shut-off device may notably have one or more flaps configured to pivot between a position referred to as open and a position referred to as closed, thereby making it possible to regulate the flow of air discharged via the additional opening or openings where applicable.

However, the space available within the motor vehicle for siting the cooling module is relatively tight. Thus, the equipment positioned around the cooling module, such as the electric motor of the electric or hybrid vehicle, may act as a potential obstacle to the air flow and/or to the flaps of the shut-off device, notably in instances in which the additional opening or openings and the shut-off device or devices associated therewith are arranged on the rear face of the cooling module. It is therefore appropriate to optimize the siting of this or these air flow discharge opening or openings according to the anticipated arrangement of the potential obstacles and according to the space available around the cooling module, while at the same time promoting a compact design of this module.

The objective of the present invention is thus to at least partially overcome the disadvantages of the prior art, and to propose an improved cooling module which allows the air flow to be discharged when the vehicle is running along, while at the same time optimizing the space available.

The present invention therefore relates to a cooling module for an electric or hybrid motor vehicle, said cooling module being intended to have an air flow passing through it, and comprising a fairing forming an internal duct in a longitudinal direction of the cooling module, and inside which at least one heat exchanger intended to have the air flow passing through it is arranged, and a collector housing positioned downstream of the fairing in the longitudinal direction, said collector housing being configured to receive a tangential-flow turbomachine, itself configured to generate the air flow, the collector housing further comprising one or more side walls which extend in the continuation of the internal duct of the fairing, the cooling module being characterized in that the at least one side wall of the collector housing comprises at least one vent intended to discharge the air flow, as well as at least one shut-off device for shutting off the at least one vent, said shut-off device being able to move between a position in which said at least one vent is open and a position in which said at least one vent is closed.

Such an arrangement of the vents within the side walls of the collector housing of the cooling module makes it possible to envisage an arrangement in which the environment around said module is arranged in such a way that the air flow can be discharged effectively via the at least one vent of the collector housing and in such a way that the pivoting flap or flaps of the shut-off device or devices are not forced to encounter one or more obstacles that may potentially be juxtaposed with the cooling module. The options for discharging the air flow from the cooling module are thus de-multiplied.

The invention may also comprise one or more of the following aspects, considered in isolation or in combination:
at least one of the two side walls which are situated one on each side of the ends of the turbomachine comprise at least one vent and at least one shut-off device;
both of the two side walls which are situated one on each side of the ends of the turbomachine comprise at least one vent and at least one shut-off device;
the vents and the shut-off devices on each of the two side walls are positioned symmetrically with respect to one another about a plane of symmetry perpendicular to the axis of rotation of the turbine of the tangential-flow turbomachine;
just one of the side walls of the collector housing which are situated one on each side of the ends of the turbomachine comprises at least one vent and at least one shut-off device for shutting off the at least one vent;
the at least one shut-off device for shutting off the at least one vent is a flap pivot-mounted about an axis of pivoting parallel to the longitudinal direction of the cooling module;
the at least one shut-off device for shutting off the at least one vent is a flap pivot-mounted about an axis of pivoting parallel to the axis of rotation of the turbine of the tangential-flow turbomachine;
the cooling module comprises a control unit which is configured to control the at least one shut-off device;
the at least one side wall of the collector housing comprises a multitude of vents;
each vent comprises its own dedicated shut-off device;
the control unit is configured to control each shut-off device independently;
the at least one shut-off device for shutting off the at least one vent comprises a seal arranged along its edges which are intended to come into contact with the at least one side wall; and
the edge or edges of the at least one vent which are intended to come into contact with the shut-off device comprise at least one seal.

Further features and advantages of the present invention will become more clearly apparent from reading the following description, which is given by way of non-limiting illustration, and with reference to the accompanying drawings, in which:

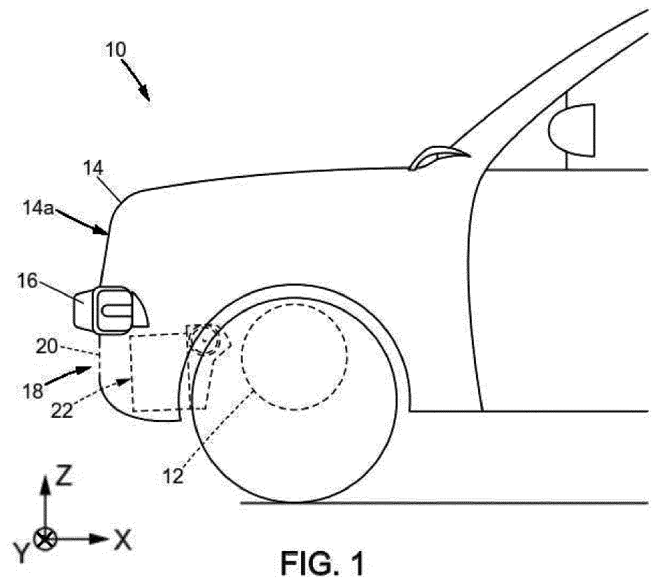

FIG. 1 shows a schematic depiction of the front of a motor vehicle in side view;

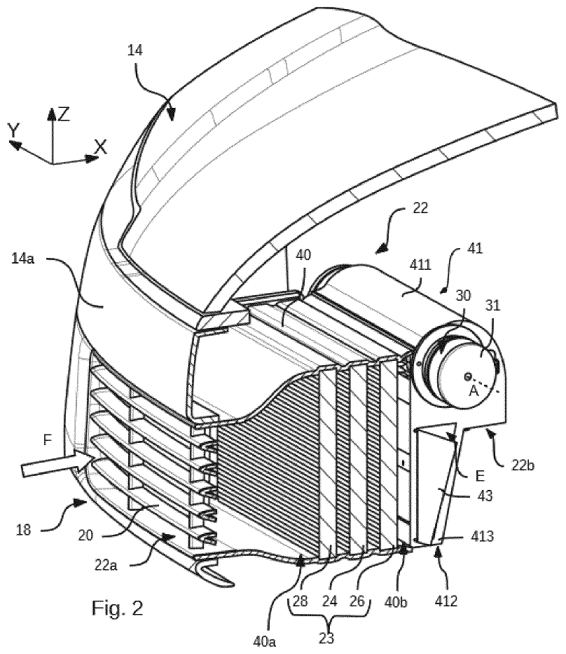

FIG. 2 shows a schematic depiction in perspective and in partial cross-section of the front of a motor vehicle and of a cooling module according to a first embodiment;

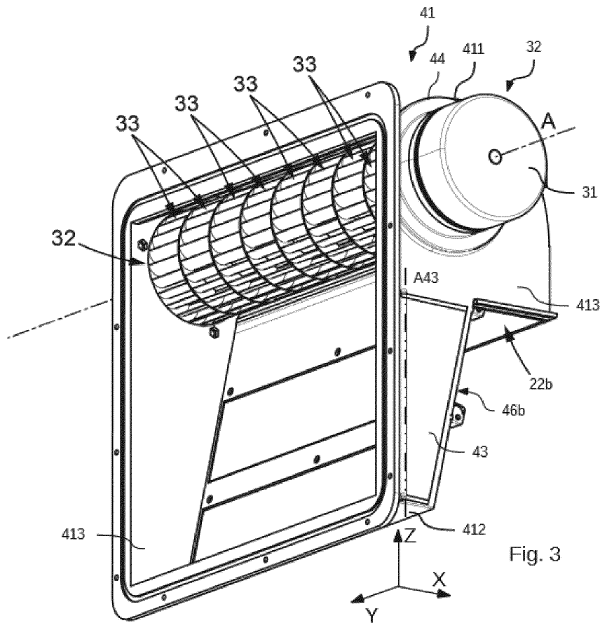

FIG. 3 shows a schematic depiction, in perspective, of the collector housing of the cooling module of FIG. 2;

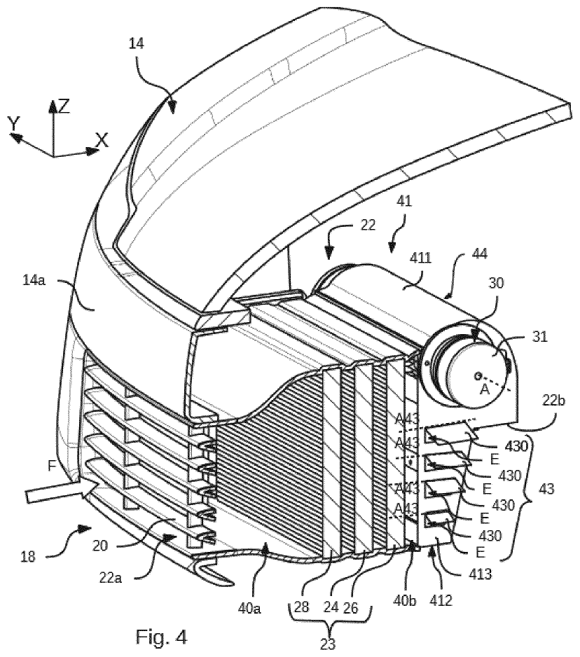

FIG. 4 is similar to FIG. 2 and shows a cooling module with a collector housing according to a variant of the first embodiment;

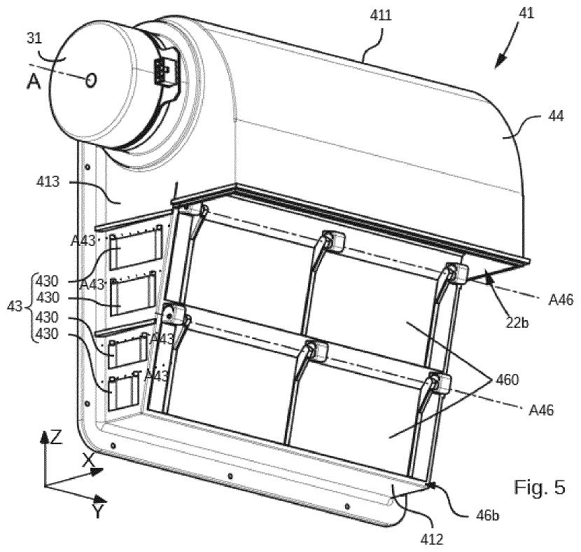

FIG. 5 shows a schematic depiction, in perspective, of the collector housing of the cooling module of FIG. 4;

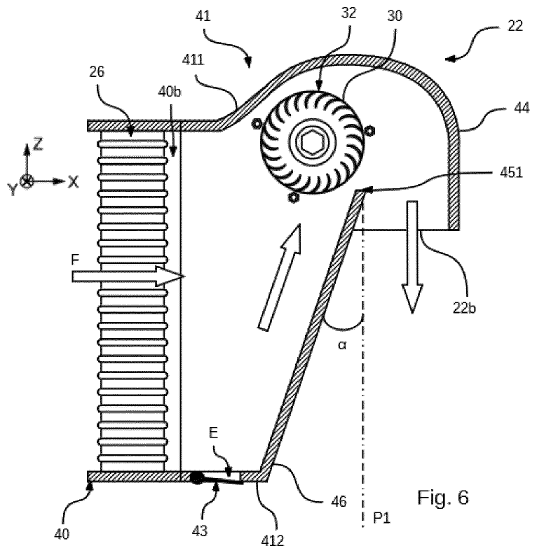

FIG. 6 shows a view in section of a second embodiment of the collector housing of the cooling module; and

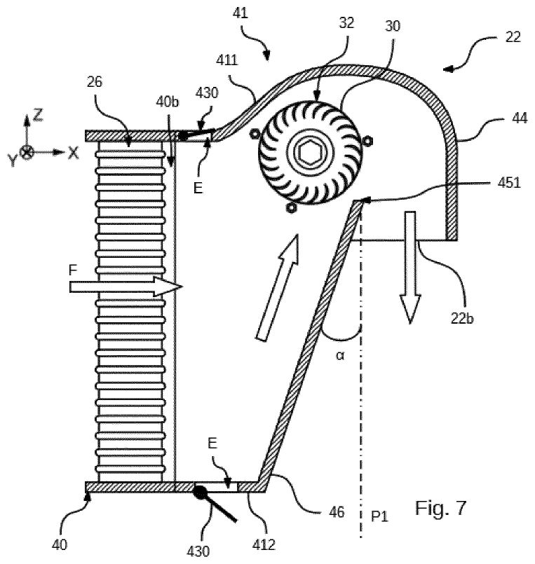

FIG. 7 is a figure similar to FIG. 6 and shows an alternative of the second embodiment of the collector housing of the cooling module.

In the various figures, identical elements bear the same reference numbers.

The following embodiments are examples. Although the description refers to one or more embodiments, this does not necessarily mean that each reference relates to the same embodiment, or that the features apply only to a single embodiment. Simple features of different embodiments can also be combined and/or interchanged to provide other embodiments.

In the present description, certain elements or parameters may be indexed, for example first element or second element and also first parameter and second parameter or first criterion and second criterion, etc. In this case, the index is used simply to differentiate between and denote elements or parameters or criteria that are similar but not identical. This indexing does not imply a priority of one element, parameter or criterion with respect to another and such denominations may easily be interchanged without departing from the scope of the present description. Neither does this indexing imply any chronological order for example in assessing any given criterion.

A trihedron XYZ is shown in all the figures in order to define the orientation of the various elements in relation to one another. A first direction, denoted X, corresponds to a longitudinal direction of the vehicle. It also corresponds to a direction opposite to the direction of forward travel of the vehicle. A second direction, denoted Y, is a lateral or transverse direction. Finally, a third direction, denoted Z, is vertical. The directions X, Y, Z are orthogonal in pairs.

In all of the figures, the cooling module according to the present invention is illustrated in a functional position, i.e. when it is positioned within a motor vehicle.

FIG. 1 schematically illustrates the front part of an electric or hybrid motor vehicle 10 which may comprise an electric motor or hybrid engine 12. The vehicle 10 notably comprises a body 14 and a bumper 16 which are supported by a chassis (not represented) of the motor vehicle 10. A cooling module 22 is positioned below the bumper 16 and facing the underbody of the motor vehicle 10. The body 14 optionally may define a cooling opening 18, that is, an opening through the body 14. This cooling opening 18 preferably faces the cooling module 22. A radiator grille 20 can optionally protect this cooling module 22.

As shown in FIGS. 2 and 4, the cooling module 22 is intended to have an air flow F passing through it parallel to the direction X, and going from the front towards the rear of the vehicle 10. The direction X corresponds more particularly to the longitudinal axis of the cooling module 22, and the air flow F circulates from an air inlet 22a to an air outlet 22b. In the present application, an element which is positioned further forward or rearward than another element is referred to respectively as being “upstream” or “downstream”, in the longitudinal direction X of the cooling module 22. The front corresponds to the front of the motor vehicle 10 in the mounted state, or to the face of the cooling module 22 through which the air flow F is intended to enter the cooling module 22. The rear, for its part, corresponds to the rear of the motor vehicle 10, or to the face of the cooling module 22 via which the air flow F is intended to exit from the cooling module 22.

Similarly, “upper” and “lower” mean an orientation in the direction Z. An “upper” element will be closer to the roof of the vehicle 10, while a “lower” element will be closer to the ground.

The cooling module 22 essentially comprises a fairing 40 forming an internal duct between an upstream end 40a and a downstream end 40b, which are opposite to one another. This internal duct is preferably oriented in the direction X such that the upstream end 40a is oriented towards the front of the vehicle 10, facing the cooling opening 18, and such that the downstream end 40b is oriented towards the rear of the vehicle 10.

At least one heat exchanger 24, 26, 28 is positioned inside said fairing 40. In FIGS. 2 to 4, the cooling module 22 comprises three heat exchangers 24, 26, 28 grouped together within a set of heat exchangers 23. However, it could comprise more or fewer depending on the desired configuration.

A first heat exchanger 24 may for example be configured to release heat energy from the air flow F. This first heat exchanger 24 may more particularly be a condenser connected to a cooling circuit (not shown), for example enabling the cooling of the batteries of the vehicle 10. This cooling circuit may for example be an air-conditioning circuit able to cool the batteries and an internal air flow destined for the motor vehicle interior.

A second heat exchanger 26 may also be configured to release heat energy into the air flow F. This second heat exchanger 26 may more particularly be a radiator connected to a thermal management circuit (not shown) for electrical elements such as the electric motor 12.

Since the first heat exchanger 24 is generally a condenser of an air-conditioning circuit, the latter needs the air flow F to be as “cool” as possible in air-conditioning mode. For this purpose, the second heat exchanger 26 is preferably positioned downstream from the first heat exchanger 24 in the direction of circulation of the air flow F. It is nevertheless entirely conceivable for the second heat exchanger 26 to be positioned upstream from the first heat exchanger 24.

The third heat exchanger 28 may itself also be configured to release heat energy into the air flow. This third heat exchanger 28 may more particularly be a radiator connected to a thermal management circuit (not shown), which can be separate from the one connected to the second heat exchanger 26, for electrical elements such as the power electronics. It is also entirely conceivable for the second 26 and the third 28 heat exchangers to be connected to a single thermal management circuit, for example connected in parallel with one another.

Again according to the example illustrated in FIGS. 2 to 4, the second heat exchanger 26 is positioned downstream from the first heat exchanger 24, whereas the third heat exchanger 28 is positioned upstream from the first heat exchanger 24. Other configurations can nevertheless be envisaged, such as, for example, the second 26 and third 28 heat exchangers both being positioned downstream or upstream from the first heat exchanger 24.

In the embodiment illustrated, each of the heat exchangers 24, 26, 28 has a generally parallelepiped form which is determined by a length, a thickness and a height. The length extends in the direction Y, the thickness extends in the direction X, and the height extends in the direction Z. The heat exchangers 24, 26, 28 thus extend on a general plane parallel to the vertical direction Z and the lateral direction Y. This general plane is thus perpendicular to the longitudinal direction X of the cooling module 22, and the heat exchangers 24, 26, 28 are therefore perpendicular to the air flow F which is intended to pass through them. The fairing 40 generally conforms to the shape of the heat exchangers 24, 26, 28 and so the internal duct of the fairing 40 therefore likewise has a parallelepipedal overall shape.

The cooling module 22 also comprises a collector housing 41 which is positioned downstream from the fairing 40 and the set 23 of heat exchangers 24, 26, 28. More specifically, the collector housing 41 is juxtaposed with the downstream end 40b of the fairing 40, and is thus aligned with the fairing 40 along the longitudinal axis X of the cooling module 22. This collector housing 41 comprises the air outlet 22b which is designed to deliver the air flow F. The collector housing 41 thus makes it possible to recuperate the air flow F which passes through the set of heat exchangers 23, and to orient this air flow F towards the air outlet 22b, this notably being illustrated by the arrows indicating the air flow F in FIGS. 6 and 7. The collector housing 41 may be integral with the fairing 40 or it can be an added-on part secured on the downstream end 40b of said fairing 40.

The collector housing 41 comprises one or more side walls 411, 412 and 413 which extend in the continuation of the internal duct of the fairing 40. In the embodiment illustrated, the internal duct of the fairing 40 has a parallelepipedal overall shape, and the upstream part of the collector housing 41 that extends the internal duct of the fairing 40 likewise also has a parallelepipedal overall shape.

The collector housing 41 more particularly comprises an upper side wall 411 and a lower side wall 412 which each extend in a plane substantially parallel to the one generated by the axes X and Y. The upper side wall 411 and the lower side wall 412 are situated facing one another. The collector housing 41 also comprises two transverse side walls 413 which each extend in a plane substantially parallel to that generated by the axes X and Z. The two transverse side walls 413 serve to connect the upper side wall 411 and the lower side wall 412, the transverse side walls 413 being situated facing one another.

The separation, in the direction Z, between the upper side wall 411 and the lower side wall 412 is notably equal to or greater than the individual height of each of the heat exchangers 24, 26, 28. Similarly, the separation, in the direction Y, between the transverse side walls 413 is for example equal to or greater than the individual length of the heat exchangers 24, 26, 28.

According to embodiments which are not illustrated in the figures, the internal duct of the fairing 40 and the collector housing 41 may have a cross-section of a shape different from that of a quadrilateral. This cross-section may notably adopt the shape of a hexagon (in which case the fairing 40 and the collector housing 41 each respectively have six side walls), of an octagon (in which case the fairing 40 and the collector housing 41 each respectively have eight side walls) or else a circular shape (in which case the fairing 40 and the collector housing 41 are cylindrical in shape and each have one single side wall that forms the shell wall of the cylinder). The cross-section depends mainly on the geometry of the at least one heat exchanger 24, 26, 28 positioned in the internal duct inside the fairing 40.

The collector housing 41 may comprise a volute 44 formed in the upper side wall 411 of said housing 41. This volute 44 at least partly delimits the air outlet 22b for the air flow. In other words, the discharge of air from the volute 44 corresponds to the air outlet 22b for the air flow F from the first collector housing 41.

The cooling module 22, more specifically the collector housing 41, also comprises at least one tangential-flow fan, also known as a tangential-flow turbomachine 30, which is configured so as to generate the air flow F passing through the set 23 of heat exchangers. This tangential-flow turbomachine 30 is arranged in the collector housing 41 such that the side walls 413 of the collector housing 41 are substantially perpendicular to the axis of rotation A of the turbine 32, as illustrated more particularly in FIG. 2. The transverse side walls 413 are more particularly situated on each side of the ends of the turbomachine 30.

The tangential-flow turbomachine 30 comprises a rotor or turbine 32 of substantially cylindrical shape. The turbine 32 advantageously has several stages of blades (or vanes), which are visible in FIGS. 6 and 7. The turbine 32 is mounted such as to rotate around an axis of rotation A which is for example parallel to the direction Y. The turbine 32 is for example positioned at the centre of the volute 44. The diameter of the turbine 32 is for example between 35 mm and 200 mm so as to limit its size. The tangential-flow turbomachine 30 is thus compact.

The tangential-flow turbomachine 30 may also comprise a motor 31 (visible in FIGS. 2 to 5) configured to rotate the turbine 32. The motor 31 is for example able to rotate the turbine 32 at a speed of between 200 rpm and 14,000 rpm. This notably makes it possible to limit the noise generated by the tangential-flow turbomachine 30.

In the examples illustrated in FIGS. 2 to 7, the tangential-flow turbomachine 30 is in a high position, notably in the upper third of the collector housing 41, preferably in the upper quarter of the collector housing 41. This notably makes it possible to protect the tangential-flow turbomachine 30 in the event of submersion, and/or to limit the space taken up by the cooling module 22 in its lower part. In this case, the air outlet 22b for the air flow F is preferably oriented towards the lower part of the cooling module 22.

It is nevertheless conceivable for the tangential-flow turbomachine 30 to be in a low position, notably in the lower third of the collector housing 41. This would make it possible to limit the space taken up by the cooling module 22 in its upper part. In this case, the air outlet 22b for the air flow would preferably be oriented towards the upper part of the cooling module 22. Alternatively, the tangential-flow turbomachine 30 can be in a median position, in particular in the median third of the height of the first collector housing 41, for example for reasons of integration of the cooling module 22 into its surroundings. These alternatives are not illustrated.

In order to guide the air from the set of heat exchangers 23 to the air outlet 22b, the collector housing 41 comprises, positioned facing the downstream end 40b of the fairing 40, a guide wall 46 for guiding the air flow F towards the air outlet 22b. The guide wall 46 more particularly comprises an upstream edge 451 (visible in FIGS. 6 and 7) making it possible to delimit the air outlet 22b for the air flow F in a complementary manner to the volute 44. Here, “upstream edge 451” means the edge of the air outlet 22b closest to the downstream end 40b of the fairing 40.

The guide wall 46 may notably be inclined with respect to a plane oriented perpendicular to the longitudinal direction X of the cooling module 22. The guide wall 46 may more particularly form an acute angle α with this plane, as illustrated notably in FIGS. 6 and 7. The angle α is for example between 10° and 23°. The inclination of the guide wall 46 allows better circulation of the air flow F within the collector housing 41 and limits pressure drops.

The guide wall 46 may comprise at least one opening as well as at least one pivoting flap 460 per opening. This at least one pivoting flap 460 makes it possible to open or close the at least one opening. More specifically, said at least one flap 460 is mounted to pivot between a position in which said opening O is open and a position in which said opening O is closed. The at least one flap 460 is mounted on an external face 46b of the guide wall 46. The external face 46b refers to that face of the guide wall 46 that is located facing the air outlet 22b.

The guide wall 46 may comprise one or more openings O. Hence, the cooling module 22 may comprise one or more flaps 460. There are notably as many flaps 460 mounted on the external face 46b of the guide wall 46 as there are openings O. In the example of FIGS. 3 and 5, the number of flaps 460 amounts to two.

The at least one flap 460 is for example mounted so as to be able to pivot about a pivot axis A46 (indicated in FIG. 5) which extends horizontally in the state mounted within the motor vehicle 10. The pivot axis A46 is therefore substantially parallel to the axis of rotation A of the tangential-flow turbomachine 30, and it is therefore perpendicular to the longitudinal direction X of the cooling module 22. The at least one pivoting flap 460 may take the form of an end-hung flap or of a centre-hung flap of butterfly type.

The at least one flap 460 is “free” or “passive” in the sense that only gravity brings the at least one pivoting flap 460 of the guide wall 46 into its closed position. In other words, the cooling module 22 does not comprise any mechanical components, or any control devices, configured to actively control the opening and/or the closing of the at least one flap 460. The at least one flap 460 is therefore always subjected to gravity, but when the motor vehicle 10 is moving at a sufficiently high speed, the air flow F passing through the cooling module 22 may exert a pressure on the at least one flap 460 in such a way as to move the latter from its closed position to its open position. In this case, the air flow F no longer passes through the volute 44 of the collector housing 41, but rather the air flow F “bypasses” the tangential-flow turbomachine 30 by passing directly through the at least one opening O in the guide wall 46.

According to the various embodiments of the cooling module 22 which are described hereinafter, the at least one opening O in the guide wall 46 is not the only type of opening provided for discharging the air flow F, because the at least one side wall 411, 412 and/or 413 of the collector housing 41 comprises at least one vent E intended to discharge the air flow F and at least one shut-off device 43 for shutting off the at least one vent E. The options for discharging the air flow F from the cooling module 22 are thus de-multiplied, making it possible both to have better circulation of the air flow F and more effective cooling within said module 22.

The shut-off device 43 for shutting off the at least one vent E is able to move between a position in which said at least one vent E is open and a position in which said at least one vent E is closed. This shut-off device 43 may notably take the form of a pivoting flap or of a multitude of pivoting flaps, such as centre-hung butterfly flaps or end-hung flaps. More particularly, the at least one shut-off device 43 for shutting off the at least one vent E is pivot-mounted to pivot about an axis of pivoting A43.

According to a first embodiment illustrated in FIGS. 2 and 3, in which the collector device 41 has a parallelepipedal overall shape, just one of the side walls 413 of the collector housing 41 which are situated one on each side of the ends of the turbomachine 30 comprises at least one vent E and at least one shut-off device 43 for shutting off the at least one vent E. The other side wall 413 therefore is not provided with a vent E (as illustrated more particularly in FIG. 3), so that it forms an insurmountable obstacle to the air flow F leaving the set 23 of heat exchangers 24, 26, 28. In other words, this side wall 413 without a vent E and the guide wall 46 act as an obstacle to the air flow F which is therefore directed towards the side wall 413 that comprises the vent or vents E so as to be discharged from the cooling module 22. This first embodiment makes it possible to limit the manufacturing steps during production.

In FIGS. 2 and 3, the side wall 413 comprises a single vent E and a single shut-off device 43, but the side wall 413 may obviously comprise a greater number of these. In this first embodiment, the pivot axis A43 is substantially parallel to the axis Z, and the pivot axis A43 therefore extends vertically when the motor vehicle 10 is in the assembled state.

This first embodiment of the collector housing 41 thus offers a particularly compact design of the cooling module 22. In FIG. 2, the shut-off device 43 of the visible side wall 413 is depicted in an open position, whereas in FIG. 3 it is depicted in a closed position.

In this particular embodiment, the air flow F is therefore intended to be discharged on just one lateral side of the cooling module 22.

It is also possible to conceive of one or more embodiments of the collector housing 41 in which the at least one side wall at 411, 412 and/or 413 comprises a multitude of vents E. Each vent E may then comprise its own dedicated shut-off device. Thus, according to a variant of the first embodiment, which variant is illustrated in FIGS. 4 and 5, the two transverse side walls 413 each comprise at least one vent E and at least one shut-off device 43 for shutting off the at least one vent E. The vent or vents E and the shut-off device or devices 43 are for example positioned symmetrically with respect to one another about a plane of symmetry perpendicular to the axis of rotation A of the turbine 32 of the turbomachine 30.

In the example of FIGS. 4 and 5, the number of vents E and that of pivoting flaps 430 of the shut-off devices 43 for each side wall 413 is four. Having a multitude of vents E and of shut-off devices 43 allows better regulation of the circulation of the air flow F as it is being discharged from the cooling module. In this variant of the first embodiment, the pivot axes A43 are substantially parallel to the longitudinal direction X of the cooling module 22, the pivot axes A43 therefore extending horizontally when the motor vehicle 10 is in the assembled state.

In FIG. 4, the pivoting flaps 430 of the shut-off devices 43 of the visible side wall 413 are depicted in an open position, whereas in FIG. 5 these pivoting flaps 430 are depicted in a closed position.

According to a second embodiment of the collector housing 41, which is illustrated in FIG. 6, and in which the collector device 41 has a parallelepipedal overall shape, just the lower side wall 412 comprises at least one vent E and at least one shut-off device 43 for shutting off the at least one vent E. The pivot axis A43 extends parallel to the axis of rotation A of the turbine 32 of the tangential-flow turbomachine 30. In FIG. 6, the flap 430 is depicted in a closed position: it blocks off the passage of the vent E.

According to an unillustrated alternative form of this second embodiment, just the upper side wall 411 comprises at least one vent E and at least one shut-off device 43 for shutting off the at least one vent E. According to another alternative form of this second embodiment of the collector housing 41 illustrated in FIG. 7, it is both the upper side wall 411 and the lower side wall 412 of the collector housing 41 that each comprise at least one vent E and at least one shut-off device 43 for shutting off the at least one vent E. In both of the alternative forms of this second embodiment, the air flow F coming from the set 23 of heat exchangers 24, 26, 28 is then intended to be discharged in a direction substantially parallel to the axis Z.

The at least one shut-off device 43 may comprise one or more seals disposed along its edges which are intended to come into contact with the one or more side walls 411, 412 and/or 413. This seal/these seals can make it possible to absorb the shock of the impact of the edges of the shut-off device 43 on the edge(s) of the at least one vent E as said shut-off device 43 starts to adopt its closed position.

Likewise, the edge or edges of the at least one vent E which are intended to come into contact with the shut-off device 43 of the side wall or walls 411, 412 and/or 413 may comprise at least one seal. This or these sales may be produced by overmoulding on the edge or edges of the at least one vent E. Alternatively, the seal(s) can be added-on parts.

In addition, the cooling module 22 can comprise a control unit (not represented in the figures) which is configured to control the shut-off device 43. The control unit can be configured to position and immobilize the shut-off device 43 in at least one intermediate position during displacement of said shut-off device 43 between its open position and its closed position.

In addition, the control unit can be configured to control each pivoting flap 430 independently. It is thus possible to conceive of configurations in which one or more pivoting flaps 430 close off the vents E to which they are attached, whereas other pivoting flaps 430 adopt an open position or else an intermediate position. Such a configuration is notably illustrated in FIG. 7 in which the pivoting flap 430 situated on the upper side wall 411 is depicted in its closed position, whereas the pivoting flap 430 situated on the lower side wall 412 is depicted in its open position.

Conversely, the at least one shut-off device 43 may be passive insofar as it has no actuator or system of actuators or else has no elastic element or elements to hold the at least one flap 430 of the shut-off device 43 in its position in which it closes the vent E.

The invention is not limited to the embodiments described with reference to the figures, and further embodiments will be clearly apparent to persons skilled in the art. In particular, the various examples may be combined, provided they are not contradictory.

1. A cooling module for an electric or hybrid motor vehicle,
said cooling module being intended to have an air flow passing through it, and comprising:
a fairing forming an internal duct in a longitudinal direction of the cooling module, and inside which at least one heat exchanger intended to have the air flow passing through it is arranged,
a collector housing positioned downstream of the fairing in the longitudinal direction, said collector housing being configured to receive a tangential-flow turbomachine, itself configured to generate the air flow, the collector housing further comprising one or more side walls which extend in the continuation of the internal duct of the fairing,
wherein the at least one side wall of the collector housing comprises at least one vent configured to discharge the air flow, as well as at least one shut-off device for shutting off the at least one vent, said shut-off device being able to move between a position in which said at least one vent is open and a position in which said at least one vent is closed.

2. The cooling module according to claim 1, wherein at least one of the two side walls which are situated one on each side of the ends of the turbomachine comprise at least one vent and at least one shut-off device.

3. The cooling module according to claim 2, wherein both of the two side walls which are situated one on each side of the ends of the turbomachine comprise at least one vent and at least one shut-off device.

4. The cooling module according to claim 3, wherein the vents and the shut-off devices on each of the two side walls are positioned symmetrically with respect to one another about a plane of symmetry perpendicular to the axis of rotation of the turbine of the tangential-flow turbomachine.

5. The cooling module according to claim 2, wherein just one of the side walls of the collector housing, which are situated one on each side of the ends of the turbomachine, comprises at least one vent and at least one shut-off device for shutting off the at least one vent.

6. The cooling module according to claim 1, wherein the at least one shut-off device for shutting off the at least one vent is a flap pivot-mounted about an axis of pivoting parallel to the longitudinal direction of the cooling module.

7. The cooling module according to claim 1, wherein the at least one shut-off device for shutting off the at least one vent is pivot-mounted about an axis of pivoting parallel to the axis of rotation of the turbine of the tangential-flow turbomachine.

8. The cooling module according to claim 1, further comprising: a control unit which is configured to control the at least one shut-off device.

9. The cooling module according to claim 1, wherein the at least one side wall of the collector housing comprises a multitude of vents.
